(19) United States
(12) Patent Application Publication
(10) Pub. No.: US 2026/0109129 A1
(43) Pub. Date: Apr. 23, 2026

(54) BINDING DEVICE

(71) Applicants: Natsuki Koike, Kanagawa (JP); Hidehiko Fujiwara, Kanagawa (JP); Riko Yagi, Kanagawa (JP)

(72) Inventors: Natsuki Koike, Kanagawa (JP); Hidehiko Fujiwara, Kanagawa (JP); Riko Yagi, Kanagawa (JP)

(73) Assignee: ETRIA Co., Ltd., Kanagawa (JP)

(21) Appl. No.: 19/336,420

(22) Filed: Sep. 22, 2025

(30) Foreign Application Priority Data
Oct. 22, 2024 (JP) 2024-186041

(51) Int. Cl. B31F 5/02; A61J 1/14; G05G 1/30

(52) U.S. Cl. CPC B31F 5/022; A61J 1/14; G05G 1/30

(57) ABSTRACT

A binding device includes a switch to manipulate, based on a push of the switch, a crimping and binding operation in which media to be bound are crimp-bound, the crimping and binding operation performed when the switch is turned on, the crimping and binding operation stopped when the switch is turned off, and a mode selector to choose one of a first operation mode in which the switch is turned on while the switch is being pushed and the switch is turned off when the switch is released and a second operation mode in which the switch is kept being turned on or the switch is kept being turned off when the switch is pushed and then released and the switch is switched between a state in which the switch is turned on and a state in which the switch is turned off every time the switch is pushed.

### CROSS-REFERENCE TO RELATED APPLICATION

This patent application is based on and claims priority pursuant to 35 U.S.C. § 119(a) to Japanese Patent Application No. 2024-186041, filed on Oct. 22, 2024, in the Japan Patent Office, the entire disclosure of which is hereby incorporated by reference herein.

### BACKGROUND

### Technical Field

The present disclosure relates to a binding device.

### Background Art

In binding devices, a switch to manipulate, based on a push of the switch by a user, a crimping and binding operation in which a plurality of media to be bound are crimp-bound is arranged. The crimping and binding operation is performed when the switch is turned on, and the crimping and binding operation is stopped when the switch is turned off.

Such binding devices are further provided with a foot switch that serves as a switch, and a crimping and binding operation is manipulated as follows. While the foot switch is kept stepped on, the switch is turned on and the crimping and binding operation is performed. When the foot switch is released and no longer stepped on, the switch is turned off and the binding operation stops. Such an operation mode may be referred to as a momentary mode.

### SUMMARY

The present disclosure described herein provides a binding device including a switch to manipulate, based on a push of the switch, a crimping and binding operation in which a plurality of media to be bound are crimp-bound, the crimping and binding operation performed when the switch is turned on, the crimping and binding operation stopped when the switch is turned off, and a mode selector to choose one of a first operation mode in which the switch is turned on while the switch is being pushed and the switch is turned off when the switch is released and a second operation mode in which the switch is kept being turned on or the switch is kept being turned off when the switch is pushed and then released and the switch is switched between a state in which the switch is turned on and a state in which the switch is turned off every time the switch is pushed.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is an external perspective view of a medicine-package binding machine.

FIG. 2 is a diagram illustrating an internal structure of a medicine-package binding machine.

FIG. 3 is a schematic diagram of a binding mechanism.

FIG. 4 is a schematic diagram of a binding mechanism viewed in a side-to-side direction.

FIG. 5 is a magnified view of a pressing mechanism and elements around the pressing mechanism.

FIG. 6 is a schematic top view of a first gear holder and elements around the first gear holder.

FIG. 7 is a schematic top view of a second gear holder and elements around the second gear holder.

FIG. 8 is a schematic diagram of a second gear at a position to apply pressure.

FIG. 9 is a schematic diagram of a second gear at a position to release pressure.

FIG. 10 is a schematic diagram of a drive transmission assembly.

FIG. 11 is a schematic plan view of an operation panel.

FIG. 12 is a schematic side view of a pair of side guides, an upper guide, and elements around those guides.

FIG. 13 is a front view of the second gear holder of FIG. 7.

FIG. 14 is a block diagram illustrating an electrical configuration of a medicine-package binding machine.

FIG. 15 is a table of operation modes.

FIG. 16A and FIG. 16B are sequence diagrams illustrating varying operation modes.

FIG. 17A and FIG. 17B are flowcharts of the control processes of varying operation modes.

FIG. 18A is a diagram illustrating a plurality of medicine packages that are coupled to each other and crimp-bound.

FIG. 18B is a diagram illustrating how medicine packages that are coupled to each other and a single medicine package are crimp-bound.

FIG. 19 is a schematic plan view of an operation panel according to a modification.

FIG. 20 is a diagram illustrating a medicine package sensor.

FIG. 21A is a flowchart of the controlling processes of a drive motor in a continuous mode, according to a first modification.

FIG. 21B is a flowchart of the controlling processes of a drive motor in an intermittent mode, according to the first modification.

FIG. 22 is a flowchart illustrating how an operation mode is set, according to a second modification.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Some embodiments of the present disclosure are described below with reference to the drawings. The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. The above-described embodiments are illustrative and do not limit the present disclosure.

Firstly, a configuration or structure of a medicine-package binding machine 1, which is an example of a binding device, is schematically described.

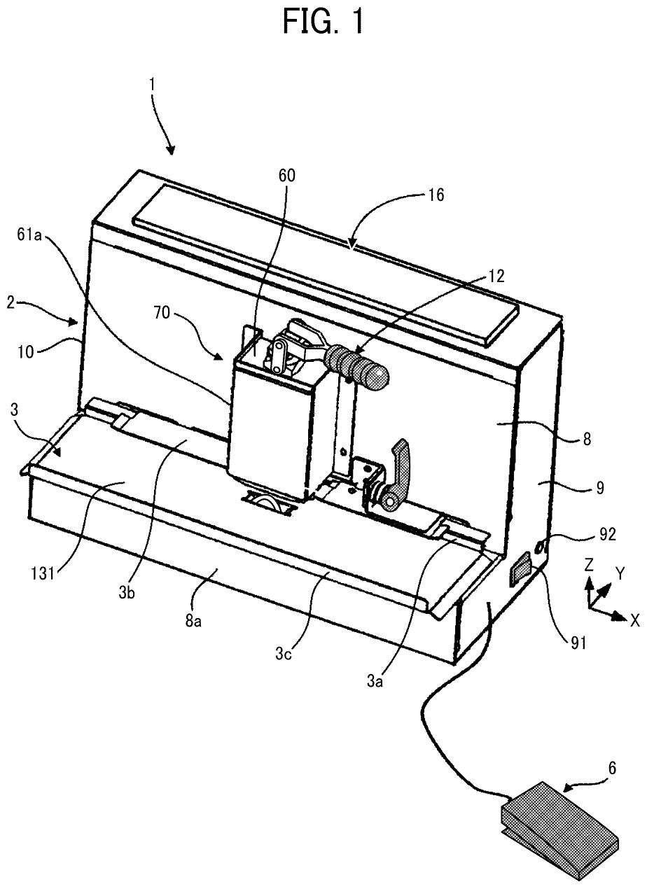

FIG. 1 is an external perspective view of the medicine-package binding machine 1.

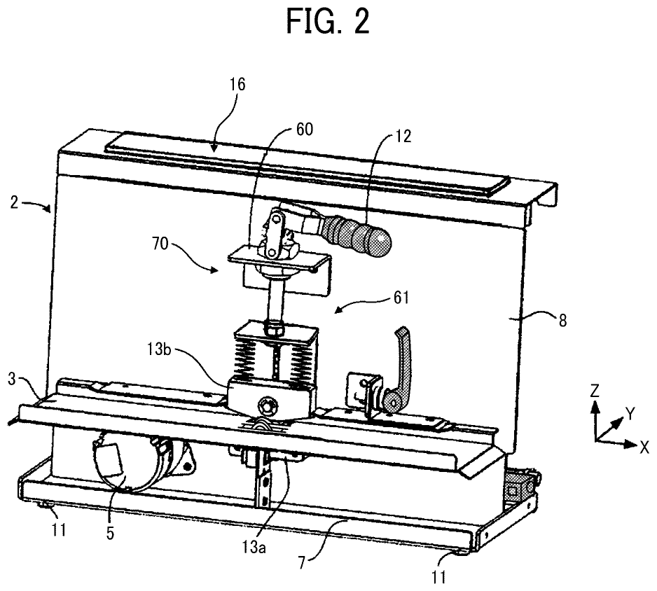

FIG. 2 is a diagram illustrating an internal structure of the medicine-package binding machine 1 of FIG. 1.

In the following description, the lateral direction, the depth direction, and the vertical direction of the medicine-package binding machine 1 are referred to as the X-axis direction, the Y-axis direction, and the Z-axis direction, respectively.

As illustrated in FIG. 1 and FIG. 2, the medicine-package binding machine 1 that is an example of a binding device includes a housing 2, a medicine-package guide 3, a foot switch 6 that is an example of a switch, an operation panel 16, and a binding mechanism 70. As illustrated in FIG. 1 and FIG. 2, the housing 2 of the medicine-package binding machine 1 includes a base panel 7 (see FIG. 2), a side panel 8, a right side-panel cover 9 (see FIG. 1), a left side-panel cover 10 (see FIG. 1), and a front side-panel cover 8a. The housing 2 is provided with a pressure-adjuster cover 61a that covers the pressure adjuster 61 (see FIG. 2) of the binding mechanism 70. The right side-plate cover 9 is provided with a power switch 91 and a power connector 92 connected to external power. The medicine-package guide 3 has a pair of side guides 3a and 3c arranged at both ends in the front-rear direction parallel to the Y-axis direction, and an upper guide 3b that is arranged at a rear portion of the binding device.

The base panel 7 illustrated in FIG. 2 is a base plate formed of sheet metal and shaped like a frame, and lower portions of the side panel 8 are fixed to the base panel 7. The base panel 7 is provided with four legs 11 that support the medicine-package binding machine 1. In FIG. 2, only two of the legs 11 on the front side are visible, and the two legs 11 on the rear side are hidden by the base panel 7 and are not visible. The binding mechanism 70 and the drive motor 5 are mounted on the side panel 8. The drive motor 5 and the base panel 7 are covered with a front side-panel cover 8a as illustrated in FIG. 1.

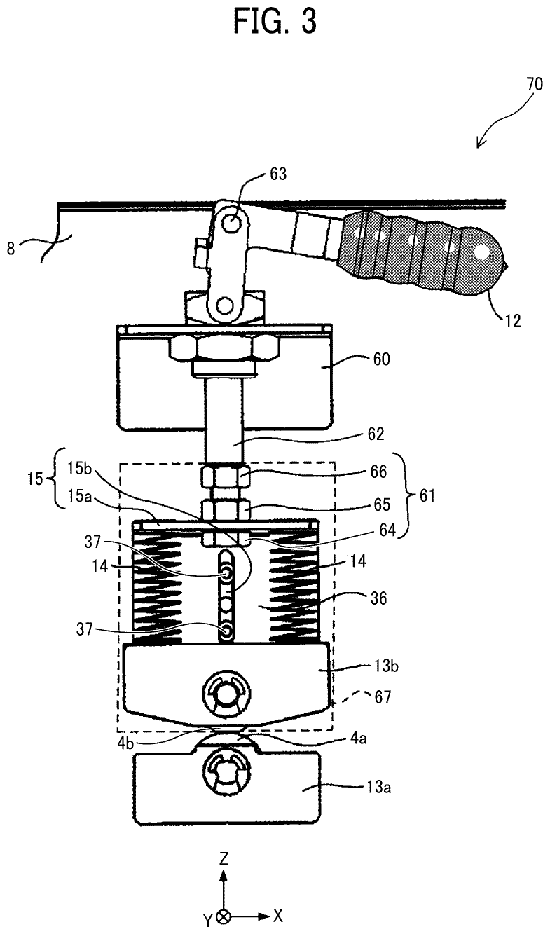

At an upper portion of the side panel 8, a pressure release lever 12 is arranged, having a bracket 60 therebetween. As will be described later, the pressure release lever 12 is operated or manipulated by an operator to apply or release the pressing force of a second gear 4a (see FIG. 3) to or from a first gear 4b (see FIG. 3).

The bracket 60 is positioned and fixed to the side panel 8, and the pressure release lever 12 and the pressure adjuster 61 that is arranged underneath are installed with reference to the bracket 60. The bracket 60 and the pressure adjuster 61 that moves as operated or manipulated by the pressure release lever 12 are covered with the pressure-adjuster cover 61a.

FIG. 3 is a schematic diagram of the binding mechanism 70.

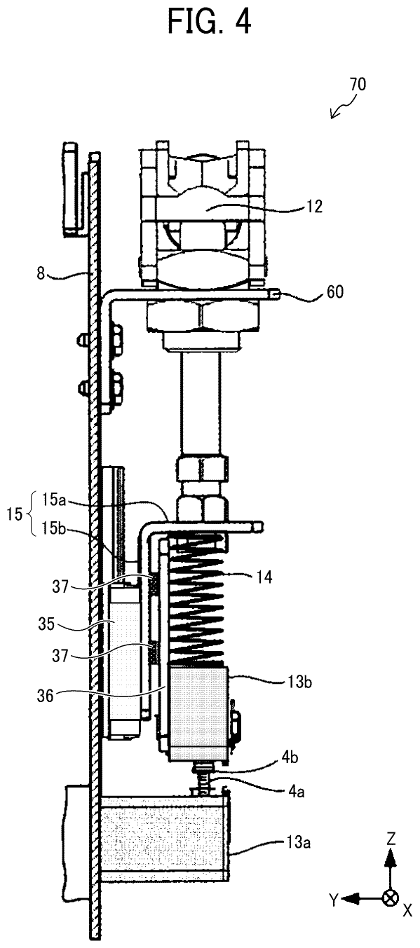

FIG. 4 is a schematic diagram of the binding mechanism 70 viewed in a side-to-side direction parallel to the X-axis direction.

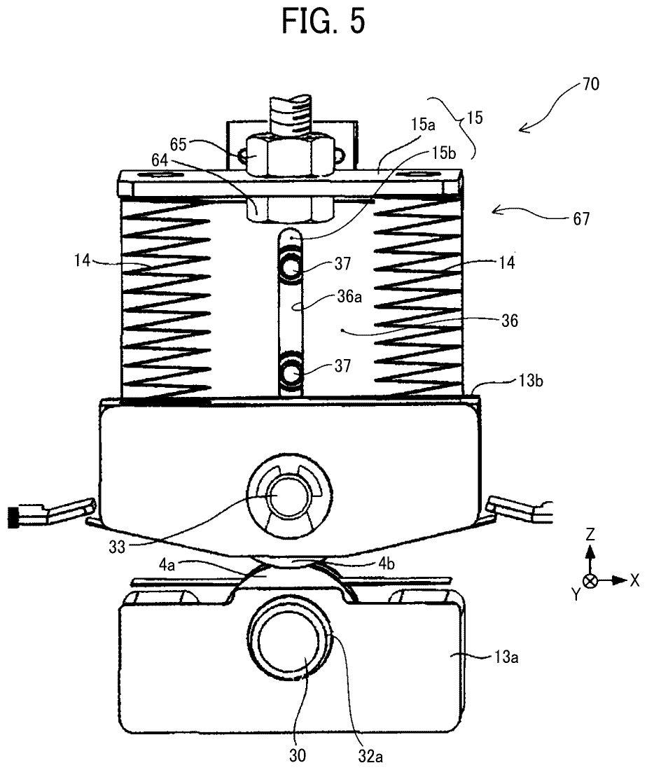

FIG. 5 is a magnified view of the pressing mechanism 67 and elements around the pressing mechanism.

The binding mechanism 70 is provided with a first gear 4a and a second gear 4b that are an example of a pair of crimpers. The binding mechanism 70 is provided with, for example, a pressing mechanism 67, a pressure adjuster 61, and a pressure release lever 12.

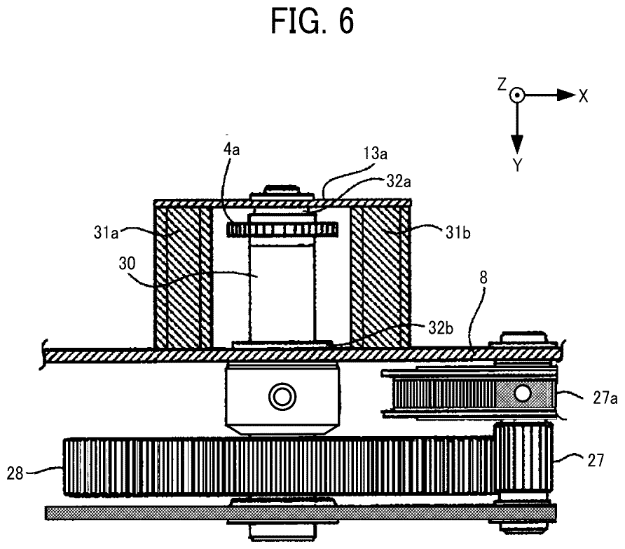

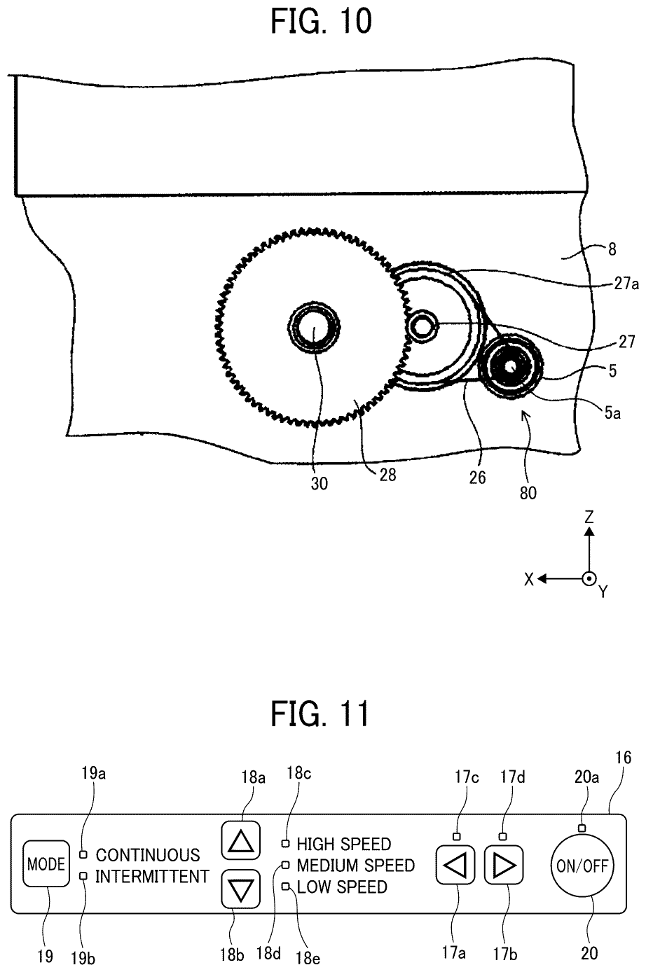

The first gear 4a is attached to the first-gear support shaft 30 so as to rotate integrally with the first-gear support shaft 30. As illustrated in the schematic view of FIG. 6 in which the peripheral area of the first gear 4a is viewed from above, the rear portion of the first-gear support shaft 30 penetrates the side panel 8, and the first-gear support shaft 30 is rotatably supported by the first gear holder 13a and the side panel 8 through a pair of bearing members 32a and 32b. At a rear end of the first-gear support shaft 30, as will be described later in detail, a drive gear 28 of a drive transmission assembly 80 (see FIG. 10) is fitted. As illustrated in FIG. 6, the first gear holder 13a is fixed to a pair of holder fixation members 31a and 31b that are fixed upright to the side panel 8.

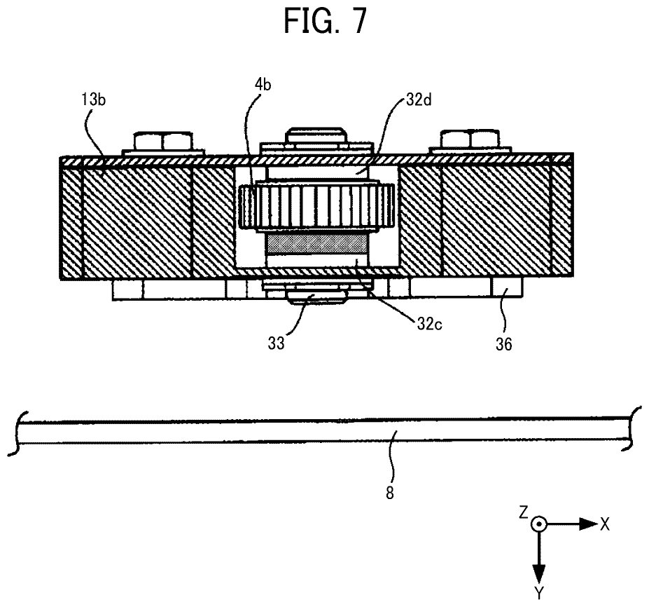

The second gear 4b is attached to the second-gear support shaft 33 so as to rotate integrally with the second-gear support shaft 33. As illustrated in the schematic view of FIG. 7 in which the peripheral area of the second gear 4b is viewed from above, the second-gear support shaft 33 is rotatably supported by the second gear holder 13b through the bearing members 32c and 32d. The second gear holder 13b is fastened to a holder slider 36 by screws. The second-gear support shaft 33 may be fixed to the second gear holder 13b, or the second gear 4b may be rotatably supported by the second-gear support shaft 33.

As illustrated in FIG. 3 to FIG. 5, the pressing mechanism 67 is provided with, for example, a pressure plate 15, a pair of pressing springs 14, and a holder slider 36 to which the second gear holder 13b is fixed. The pressure plate 15 has a top face 15a and a side face 15b, and the side face 15b is supported by a linear guide 35 fixed to the side panel 8, so as to be movable in a predetermined range in the vertical direction parallel to the Z-axis direction.

To the side face 15b of the pressure plate 15, a pair of stepped pins 37 are fixed in the vertical direction parallel to the Z-axis direction. These two stepped pins 37 are inserted into a long hole 36a of the holder slider 36, which extends in the vertical direction parallel to the Z-axis direction, and the holder slider 36 is held by these two stepped pins 37 so as to be movable by a specified distance in the vertical direction parallel to the Z-axis direction, with respect to the pressure plate 15.

The pair of pressing springs 14 are horizontally arranged in the X-axis direction with reference to the second-gear support shaft 33. These pressing springs 14 are fitted in a compressed state between the second gear holder 13b and the top face 15a of the pressure plate 15 with the bottom ends thereof locked to the second gear holder 13b and the top ends thereof locked to the top face 15a of the pressure plate 15. Due to such a configuration, the second gear holder 13b is biased downward toward the first gear 4a by the pair of pressing springs 14, and the second gear 4b held by the second gear holder 13b contacts the first gear 4a with a predetermined pressure.

As illustrated in FIG. 3, the pressure adjuster 61 includes a bolt 64 and a pair of nuts 65 and 66, and the bolt 64 is screwed into the internal threads formed on the inner side of a cylindrical shaft 62. The top face 15a of the pressure plate 15 is held and fixed by the head of the bolt 64 and the nut 65. A nut 66 is used to screw the bolt 64 to the cylindrical shaft 62.

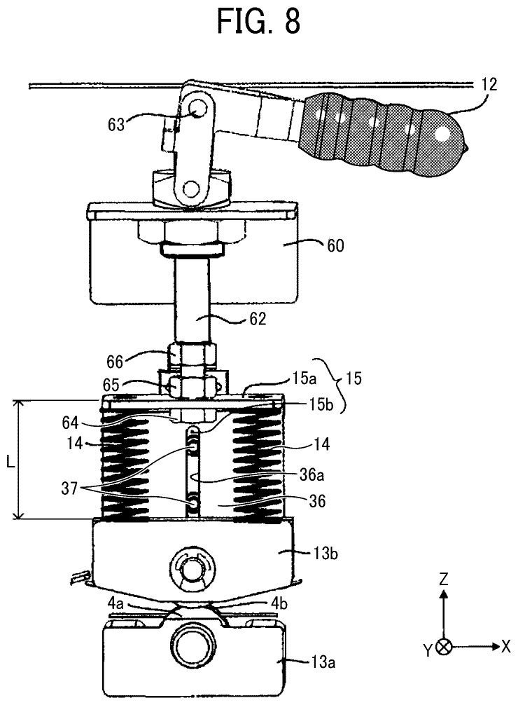

The pressure adjuster 61 adjusts the pressurizing force of the second gear 4b to the first gear 4a by adjusting the vertical position of the bolt 64 screwed into the cylindrical shaft 62. More specifically, the second gear 4b is positioned at a position where the first gear 4a is pressed, and the vertical position of the bolt 64 is adjusted. When the bolt 64 is screwed into the cylindrical shaft 62, the pressure plate 15 moves up relative to the holder slider 36 which is biased downward by the pair of pressing springs 14. Accordingly, a length L illustrated in FIG. 8 between the second gear holder 13b and the top face 15a of the pressure plate 15 increases, and the amount of compression of the pair of pressing springs 14 is reduced. As a result, the pressing force of the pair of pressing springs 14 against the second gear holder 13b decreases, and the pressing force of the second gear 4b against the first gear 4a is reduced.

By contrast, when the bolt 64 is loosened from the cylindrical shaft 62, the pressure plate 15 moves downward relative to the holder slider 36 which is biased downward by the pair of pressing springs 14. Accordingly, the length L illustrated in FIG. 8 between the second gear holder 13b and the top face 15a of the pressure plate 15 decreases, and the amount of compression of the pair of pressing springs 14 increases. As a result, the pressing force of the pair of pressing springs 14 against the second gear holder 13b increases, and the pressing force of the second gear 4b against the first gear 4a increases. When the pressing force of the second gear 4b against the first gear 4a falls within a desired range, the nut 66 is screwed and fixed such that the bolt 64 will not be loosened.

The cylindrical shaft 62 is held by the bracket 60 so as to be movable in the vertical direction, and the top end of the cylindrical shaft 62 is attached to the pressure release lever 12 through a link mechanism. The pressure release lever 12 is rotatably supported by a fulcrum pin 63 provided for the bracket 60.

FIG. 8 is a schematic diagram of the second gear 4b at a position to apply pressure.

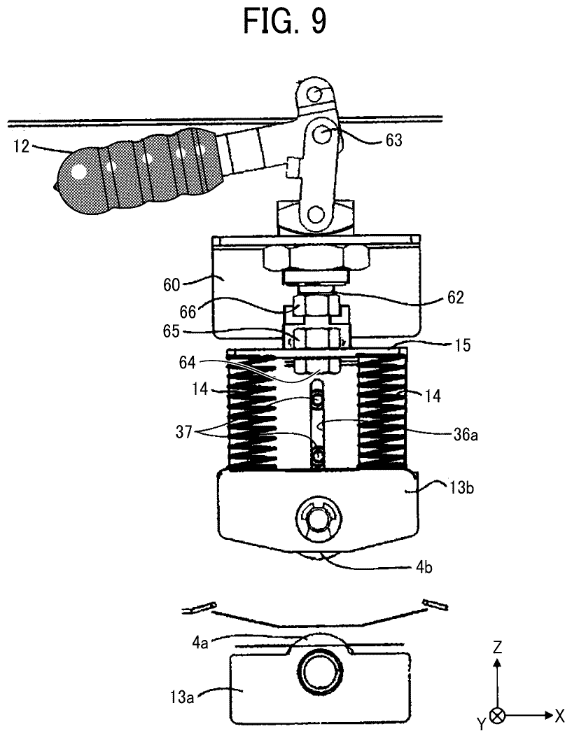

FIG. 9 is a schematic diagram of the second gear 4b at a position to release pressure.

The pressure release lever 12 is supported by the fulcrum pin 63 so as to be rotatable by about 180 degrees, and as illustrated in FIG. 8, the pressure release lever 12 is tilted to the right when pressing operation is in progress. By contrast, when the pressing force is released, as illustrated in FIG. 9, the pressure release lever 12 is tilted to the left.

As illustrated in FIG. 8, when the pressure release lever 12 is tilted to the right, the second gear 4b contacts the first gear 4a with a predetermined pressing force. When the pressure release lever 12, as illustrated in FIG. 8, is rotated by 180 degrees by an operator, the rotation of the pressure release lever 12 is converted into linear motion in the vertical direction by the link mechanism, and the cylindrical shaft 62 moves upward. When the cylindrical shaft 62 moves upward, the pressure plate 15 that is held between the bolt 64 and the nut 65 of the pressure adjuster 61 moves upward as guided by the linear guide 35.

When the upper stepped pin of the two stepped pins 37 of the pressure plate 15 abuts against the upper end of the 36a of the long hole portion of the holder slider 36, the holder slider 36 rises together with the pressure plate 15. As a result, the second gear holder 13b that is fixed to the holder slider 36 moves upward, and the second gear 4b that is held by the second gear holder 13b is separated from the first gear 4a. Accordingly, the pressure is released. When the pressure release lever 12 is tilted to the left as illustrated in FIG. 9, the second gear 4b is located at a position to release pressure, which is sufficiently spaced from the first gear 4a.

FIG. 10 is a schematic diagram of the drive transmission assembly 80 that transmits the driving force of the drive motor 5 to the first gear 4a.

The drive transmission assembly 80 is arranged on the rear side of the side panel 8, and includes a timing belt 26 looped over a motor shaft 5a of the drive motor 5 and a pulley 27a, a pulley gear 27 arranged coaxially and integrally with the pulley 27a, and the drive gear 28 that engages with the pulley gear 27. The drive gear 28 is attached to the rear end of the first-gear support shaft 30 so as to rotate integrally with the first-gear support shaft 30 provided with the first gear 4a (see also FIG. 6).

When the drive motor 5 is driven to rotate, the pulleys gear 27 rotate together with the pulley 27a through the timing belt 26, and the drive gear 28 that engages with the pulley gear 27 rotates. As a result, the first gear 4a is driven to rotate through the first-gear support shaft 30. When the drive motor 5 rotates in the clockwise (CW) direction, the drive transmission assembly 80 drives the first gear 4a to rotate in the counterclockwise (CCW) direction at a predetermined speed-reduction ratio.

FIG. 11 is a schematic plan view of the operation panel 16 arranged on a top face of the housing 2 of the medicine-package binding machine 1.

On the operation panel 16, first and second rotation-direction display lamps 17c and 17d, a rotation-speed adjustment switches 18a and 18b that are an example of a rotation-speed switch, and rotation-speed indicators 18c, 18d, and 18e are arranged. On the operation panel 16, a mode switch 19 that is an example of a mode selector, a pair of mode indicators 19a and 19b, an on-off switch 20, and an on-off indicator 20a are further arranged

The first and second rotation-direction switches 17a and 17b are used to switch the rotation direction of the first gear 4a to switch the conveyance direction of a medicine package. When the medicine package is to be conveyed from right to left, the first rotation-direction switch 17a on the left is touched or pressed down to turn on the light-emitting diode (LED) of a first rotation-direction display lamp 17c on the left. When the medicine package is to be conveyed from left to right, on the contrary, the second rotation-direction switch 17b on the right is touched or pressed down to turn on the LED of a second rotation-direction display lamp 17d.

The rotation-speed adjustment switches 18a and 18b control the number of revolutions per minute (rpm) of the drive motor 5 to switch the rotation speed of the first gear 4a among a plurality of stages such as three stages. The rotation-speed adjustment switches 18a and 18b serve as a number-of-revolution setting unit or a rotation-speed setting unit to adjust the number of revolutions per minute or the rotation speed of the drive motor 5 in a one-time binding operation. Each one of the three rotation-speed indicators 18c, 18d, and 18e has an LED lamp that is turned on depending on the three-stage rotation speed, including low speed, medium speed, and high speed, which is switched by an operation made on the rotation-speed adjustment switches 18a and 18b. It is desired that the range of the changeable rotation speed of the first gear 4a be equal to or faster than 5 millimeters (mm) per second (sec) and equal to or slower than 30 mm/sec. The speed of binding operation can be adjusted to a convenient-to-use speed for an operator by switching the changeable rotation speed of the first gear 4a with the rotation-speed adjustment switches 18a and 18b.

The mode switch 19 is used to switch the operation mode of the medicine-package binding machine 1. Every time the mode switch 19 is touched or pressed down, the operation mode sequentially changes between an intermittent mode and a continuous mode, which correspond to the first operation mode and the second operation mode, respectively. By turning on one of the LEDs of the pair of mode indicators 19a and 19b that are arranged on the right of the mode switch 19, which of the operation modes is currently active is indicated. The operation modes will be described later in detail.

The on-off switch 20 that is an example of a switch and a button switch is used to start and stop the binding operation of medicine packages. By operating the on-off switch 20, the started state and stopped state of the binding operation for medicine packages can be checked as the LED of the on-off indicator 20a is turned on or off.

With the foot switch 6 illustrated in FIG. 1, which is an example of a switch, a binding operation for medicine packages can be performed with manipulations equivalent to those for the above-described on-off switch 20. When a medicine-package binding operation is performed as manipulated by the foot switch 6, the result of the operation can be checked with the on-off indicator 20a. For example, no LED is turned off when the binding operation for medicine packages is stopped, and a green LED is turned on when the binding operation for medicine packages is in progress. Moreover, a red LED is turned on in the event of an error.

The foot switch 6 is attachable to and detachable from the housing 2. When the foot switch 6 is coupled to the housing 2, the on-off switch 20 is disabled. When the foot switch 6 is detached from the housing 2, the on-off switch 20 is usable.

FIG. 12 is a schematic side view of a pair of side guides, an upper guide, and elements around those guides, which are used to bind a plurality of medicine packages.

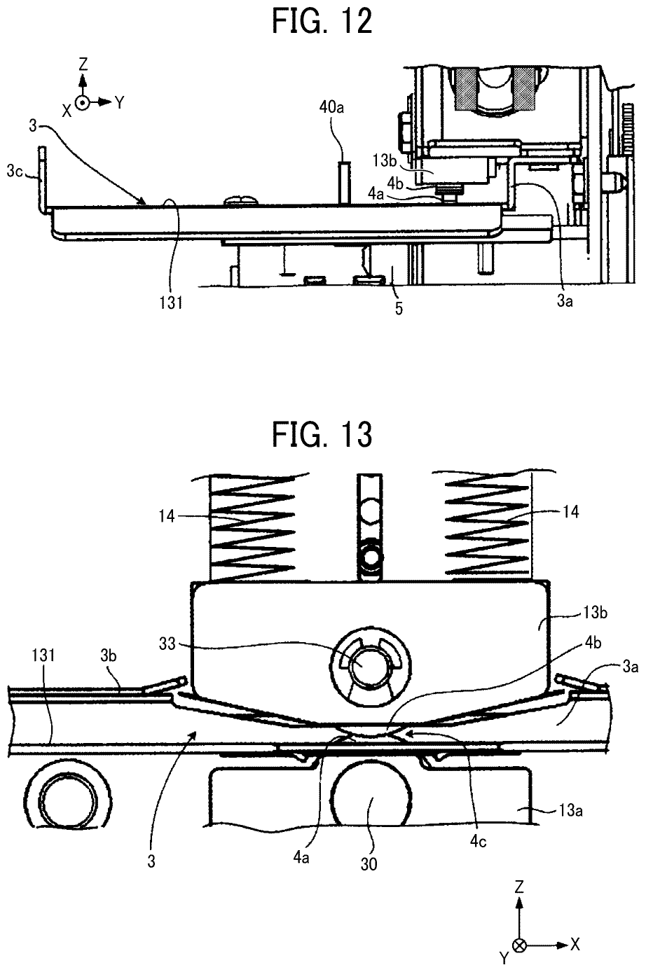

FIG. 13 is a front view of the second gear holder 13b FIG. 7.

The medicine-package guide 3 supports a plurality of medicine packages on the top face of the guiding surface 131, and as illustrated in FIG. 13, has the pair of side guides 3a and 3c and the upper guide 3b. The pair of side guides 3a and 3c are arranged at the ends of the medicine-package guide 3 in the front-rear direction. The upper guide 3b may be omitted. With the omission of the upper guide 3b, a plurality of medicine packages can easily be stacked on top of one another and set, and a medicine-package bundle that has been crimp-bound can easily be taken out. With the upper guide 3b, even when the ends of the medicine packages near a rear portion of the binding device are bent upward, the multiple medicine packages that are stacked on top of each other can be guided as desired, and the binding positions of the medicine packages can be prevented from being misaligned from desired positions.

The multiple medicine packages that are stacked on the guiding surface 131 of the medicine-package guide 3 are guided to an engagement portion 4c between the first gear 4a and the second gear 4b as guided by the medicine-package guide 3. Both ends of the bottom face of the second gear holder 13b in the horizontal direction parallel to the X-axis direction are inclined and descend toward the engagement portion 4c, and the bottom face of the second gear holder 13b is an example of a guide that guides the multiple medicine packages stacked on top of each other to the engagement portion 4c.

The first gear 4a and the second gear 4b are pressed at a predetermined level of pressure. When the on-off switch 20 or the foot switch 6 is turned on, the drive motor 5 starts driving. Accordingly, the first gear 4a starts rotating, and the second gear 4b rotates together with the first gear 4a. As operated by an operator, the medicine packages that are stacked on top of each other and are inserted into the engagement portion between the first gear 4a and the second gear 4b are crimp-bound by the first gear 4a and the second gear 4b and are conveyed.

When the on-off switch 20 or the foot switch 6 is turned off, the drive motor 5 stops rotating. Accordingly, the first gear 4a and the second gear 4b stops rotating. Moreover, the binding operation stops, and the conveyance of a medicine package stops.

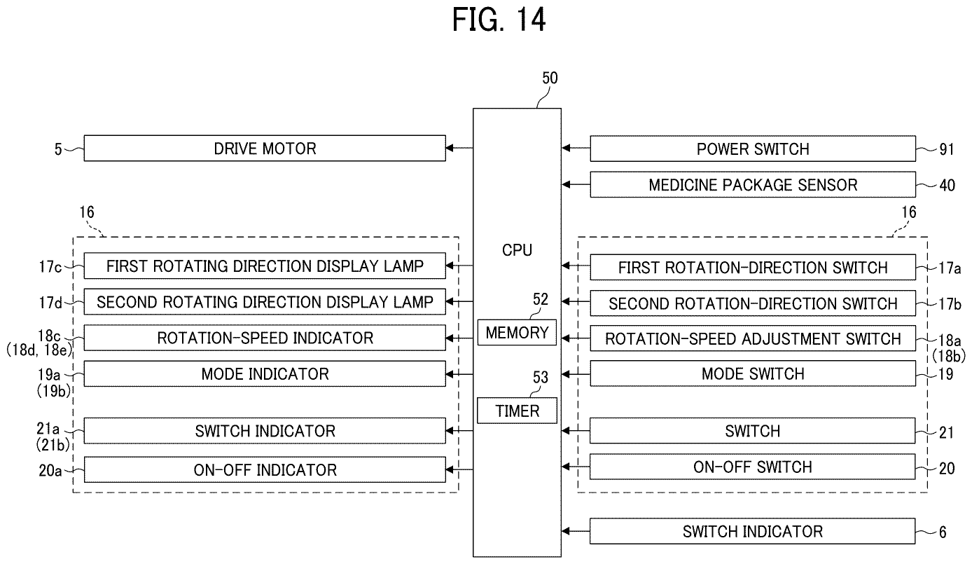

FIG. 14 is a block diagram illustrating an electrical configuration of the medicine-package binding machine 1.

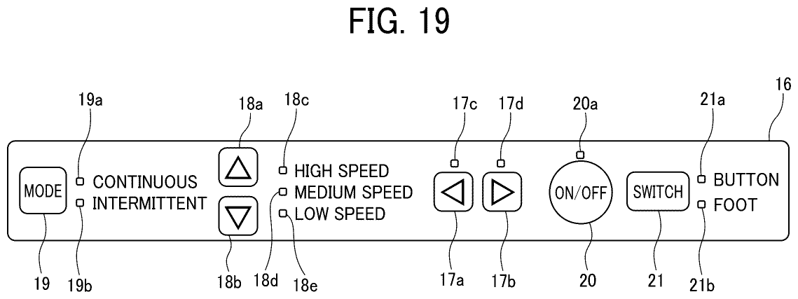

The controller 50 includes, for example, a central processing unit (CPU), a memory 52 such as a read-only memory (ROM) and a random-access memory (RAM), and a timer 53, and these elements are implemented on a control board. The drive motor 5, the medicine package sensor 40, the power switch 91, the foot switch 6, and various kinds of switches and indicators of the operation panel 16 are coupled to the controller 50. A switch 21 and a pair of switch indicators 21a and 21b depicted in FIG. 14 are additional components of the operation panel 16 illustrated in FIG. 19.

The operation on the operation panel 16 or the foot switch 6 is sent to the controller 50, and the controller 50 controls various kinds of operation based on the operation. The drive motor 5 uses a direct-current (DC) servo motor with which a feeding position can be controlled by pulse, and is controlled by a pulse signal sent from the controller 50. Due to such configurations as described above, the amount of feed of a medicine package can accurately be controlled. Although the stepping motor can accurately control the amount of feed of the medicine package, the torque varies greatly depending on, for example, the number of medicine packages to be bound, the materials of the medicine packages to be bound, and the positions of the medicines inside each of the medicine packages. For this reason, step-out may occur with the use of a stepping motor, and it is desired that a DC servo motor be used as the drive motor 5.

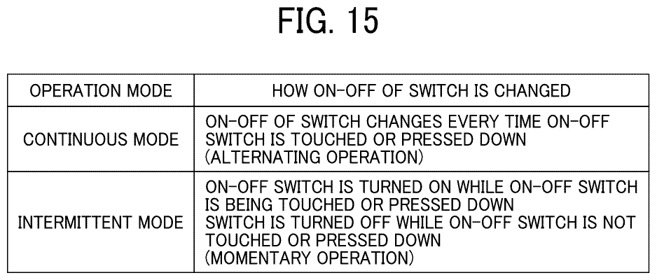

FIG. 15 is a table of operation modes.

A continuous mode is the second operation mode in which the on-off of the switch changes every time the on-off switch 20 is touched or pressed down or every time the foot switch 6 is stepped on, which may be referred to as an alternate mode. More specifically, when the on-off switch 20 is touched or pressed down, the switch is turned on, and even when a hand is released from the on-off switch 20 afterward, the turned-on state is maintained. Accordingly, the pair of gears starts rotating, and a medicine-package binding operation is performed. When the on-off switch 20 is touched or pressed down again, the switch is turned off, and the pair of gears stops rotating. Accordingly, the medicine-package binding operation stops. In the case of the foot switch 6, when the foot switch 6 is stepped on and released therefrom, the switch is turned on. When the foot switch 6 is stepped on again, the switch is turned off.

Moreover, an intermittent mode is the first operation mode in which the switch is turned on while the on-off switch 20 is being touched or pressed down or while the foot switch 6 is being stepped on. The intermittent mode is an operation mode that adopts a so-called momentary operation in which the switch is turned off when a hand is released from the on-off switch 20 or when a foot is released from the foot switch 6. More specifically, while the on-off switch 20 is kept pressed touched or pressed down, the switch is turned on, and a medicine-package binding operation is performed. By contrast, when a hand is released from the on-off switch 20, the switch is turned off, the medicine-package binding operation stops. In the case of the foot switch 6, the switch is turned on while the foot switch 6 is kept stepped on, and the switch is turned off when a foot is released from the foot switch 6.

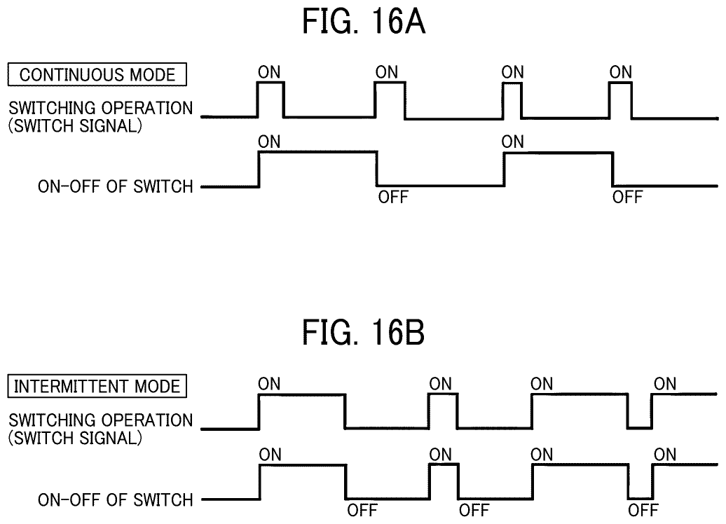

FIG. 16A and FIG. 16B are sequence diagrams illustrating varying operation modes.

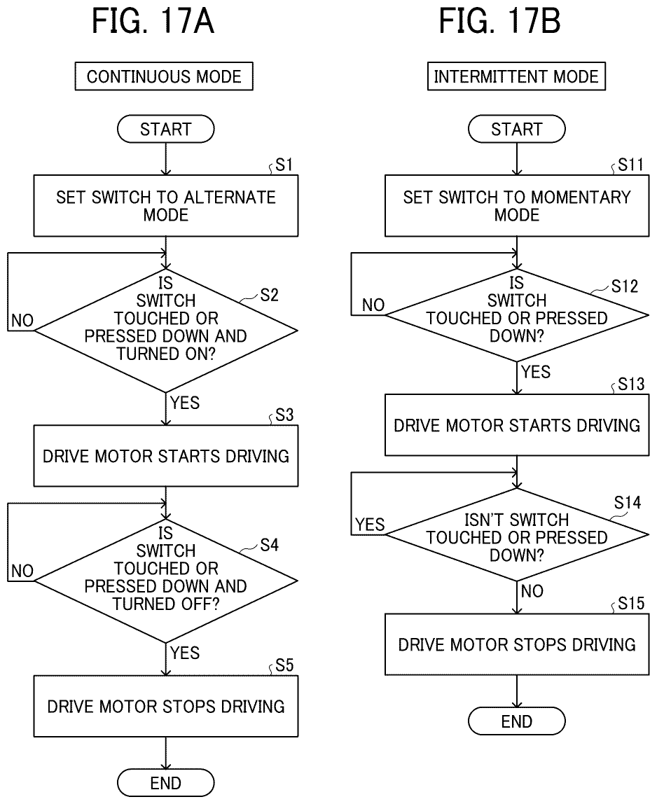

FIG. 17A and FIG. 17B are flowcharts of the control processes of varying operation modes.

As illustrated in FIG. 17A, when an operator or user manipulates the mode switch 19 of the operation panel 16 to choose a continuous mode, in step S1, the operation of a switch such as the on-off switch 20 and the foot switch 6 is set to an alternate mode. Subsequently, when the switch is touched or pressed down by an operator (YES in step S2), in step S3, the drive motor 5 starts driving. Accordingly, the pair of gears starts rotating, and a medicine-package binding operation is performed. More specifically, as illustrated in FIG. 16A, when the switch is touched or pressed down and the controller 50 receives a turning-on signal from the switch, the switch is turned on. When the switch is turned on, the drive motor 5 is turned on. Accordingly, the pair of gears starts rotating, and a medicine-package binding operation is performed.

When the switch is touched or pressed down again by an operator (YES in step S4), in step S5, the drive motor 5 stops driving, and the medicine-package binding operation stops. More specifically, as illustrated in FIG. 16A, when the controller 50 receives a turning-on signal from the switch again, the controller 50 switches the switch from on to off. When the switch is turned off, the controller 50 turns off the drive motor 5, and stops the rotation of the pair of gears. Accordingly, the medicine-package binding operation stops.

As illustrated in FIG. 17B, when an operator manipulates the mode switch 19 of the operation panel 16 to choose an intermittent mode, in step S11, the operation of the switch such as the on-off switch 20 and the foot switch 6 is set to a momentary mode. Subsequently, when the switch is kept being touched or pressed down by an operator (YES in step S12), in step S13, the drive motor 5 starts driving. Accordingly, the pair of gears starts rotating, and a medicine-package binding operation is performed. When the switch that has been touched or pressed down is released (YES in step S14), in step S15, the drive motor 5 stops driving, and the medicine-package binding operation stops.

More specifically, as illustrated in FIG. 16B, when the switch is touched or pressed down and the controller 50 receives a turning-on signal from the switch, the controller 50 turns on the switch to turn on the drive motor 5. Accordingly, the pair of gears starts rotating, and a medicine-package binding operation is performed. When the controller 50 no longer receives a turning-on signal from the switch, the controller 50 turns off the switch to turn off the drive motor 5. Accordingly, the pair of gears stops rotating, and the medicine-package binding operation is stopped.

As described above, according to the present embodiment, two operation modes are arranged, including the continuous mode that adopts an alternating operation and the intermittent mode that adopts a momentary operation. Due to such a configuration, crimp binding can be performed in an appropriate operation mode depending on how crimp binding is to be performed.

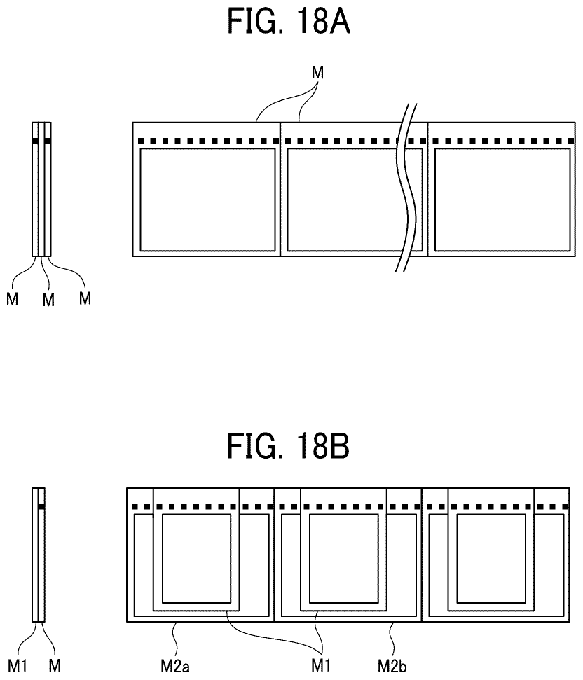

As illustrated in FIG. 18A, a continuous mode that adopts an alternating operation is an operation mode that is recommended when a plurality of medicine packages that are coupled to each other in the conveyance direction are continuously crimp-bound. When a plurality of medicine packages that are coupled to each other in the conveyance direction are to be continuously crimp-bound, a continuous mode is selected. Due to such a configuration, without continuously touching or pressing down the switch such as the on-off switch 20 or the foot switch 6, the pair of gears can be driven to rotate, and a plurality of medicine packages can continuously be crimp-bound. Accordingly, the workload of an operator can be reduced, and crimp binding can easily be performed.

By contrast, as illustrated in FIG. 18B, an intermittent mode that adopts a momentary operation is an operation mode that is recommended when medicine packages that are coupled to each other and a single medicine package are to be crimp-bound. As illustrated in FIG. 18B, when medicine packages that are coupled to each other and a single medicine package are to be crimp-bound, a single medicine package M1 is placed on a front-end medicine package M2a in the conveyance direction of the medicine packages coupled to each other, and then a crimping and binding operation is performed. As a result, the front-end medicine package M2a of the medicine packages coupled to each other and the single medicine package M1 are crimp-bound. When the front-end medicine package M2a of the medicine packages coupled to each other in the conveyance direction and the single medicine package M1 are crimp-bound and the medicine packages M have passed through the engagement portion of the pair of gears, the medicine-package binding operation pauses. When the single medicine package M1 is placed on a second medicine package M2b of the medicine packages coupled to each other in the conveyance direction, the medicine-package binding operation resumes, and the single medicine package M1 and the second medicine package M2b of the medicine packages coupled to each other in the conveyance direction are crimp-bound. As described above, when medicine packages that are coupled to each other and a single medicine package are to be crimp-bound, crimp binding is to be performed intermittently. When crimp binding is to be performed intermittently as above, the switch such as the on-off switch 20 or the foot switch 6 is to be operated or manipulated frequently.

When crimp binding is to be performed intermittently as above, the operation mode is set to an intermittent mode that adopts a momentary operation. By so doing, compared with the continuous mode that adopts an alternating operation, for example, the stop position of medicine packages can easily be adjusted in a delicate manner, and medicine packages that are coupled to each other and a single medicine package can easily be crimp-bound without an error.

In the above embodiments, when the foot switch 6 is coupled to the housing 2, the on-off switch 20 is disabled. However, no limitation is indicated thereby. Even when the foot switch 6 is coupled to the housing 2, the on-off switch 20 may be made available. More specifically, as illustrated in FIG. 19, the switch 21 with which the switch to be used can be selected, which is an example of a switch selector, may be arranged on the operation panel 16. Every time the switch 21 is touched or pressed down, the switch to be used sequentially changes between the on-off switch 20 and the foot switch 6. On the right side of the switch 21, which one of the switches is currently active is indicated by turning on one of the LEDs of the pair of switch indicators 21a and 21b. When the switch indicator 21a is turned on and lit, the on-off switch 20 is usable, and the foot switch 6 is disabled. On the other hand, when the switch indicator 21b is turned on and lit, the foot switch 6 is usable, and the on-off switch 20 is disabled. Due to such a configuration, the on-off switch 20 may be made available even when the foot switch 6 is coupled to the housing 2.

Modifications of the above embodiments are described below.

### First Modification

In a first modification of the above embodiments of the present disclosure, a medicine package sensor that is an example of a medium sensor and detects the entry of a medicine package into a binder, i.e., an engagement portion 4c between the first gear 4a and the second gear 4b is arranged, and the on-off of the drive motor 5 is controlled based on the detection results of the medicine package sensor and the operation made on the switch.

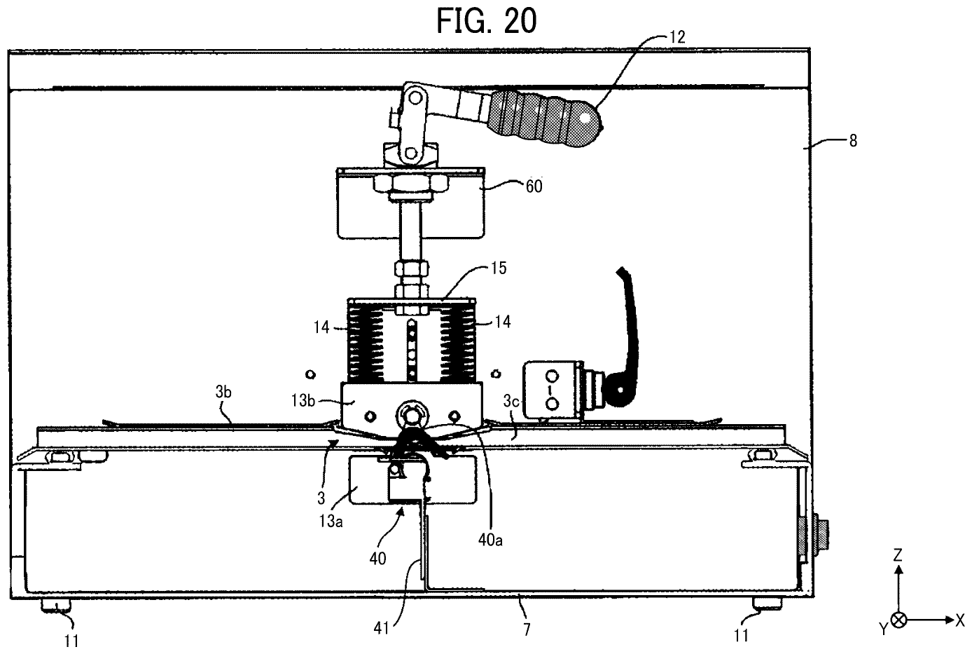

FIG. 20 is a diagram illustrating a medicine package sensor 40 that detects the entry of a medicine package into a binder, i.e., the engagement portion 4c between the first gear 4a and the second gear 4b.

The medicine package sensor 40 includes a detection unit 40a part of which protrudes from a guiding surface of the medicine-package guide 3 and a sensor that detects the movement of the detection unit 40a, and is held by a bracket 41 fixed to the base panel 7 that is also referred to as a bottom plate.

The detection unit 40a moves downward or rotates such that a portion of the detection unit 40a protruding from the guiding surface of the medicine-package guide 3 is retracted from the guiding surface by the medicine package moving to the engagement portion 4c, i.e., a binder, between the first gear 4a and the second gear 4b. As the sensor detects the motion of the detection unit 40a, the entry of a medicine package into the above-described engagement portion 4c is detected.

Both when the bundle of medicine packages moves from left to right and when the bundle of medicine packages moves from right to left, the medicine package sensor 40 can detect a medicine package before the bundle of medicine packages enters a binder, i.e., the engagement portion 4c between the first gear 4a and the second gear 4b. More specifically, both when the bundle of medicine packages moves from left to right and when the bundle of medicine packages moves from right to left, the shape of the detection unit 40a is appropriately formed such that the detection unit 40a can move or rotate as desired and the sensor can detect the movement of the detection unit 40a before the bundle of medicine packages enters the engagement portion 4c.

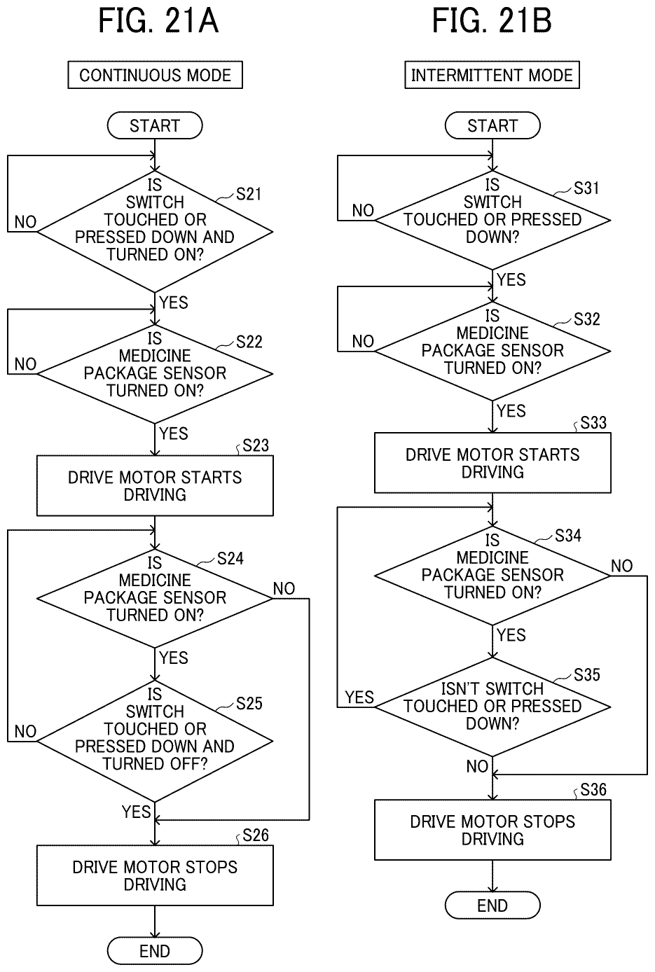

FIG. 21A is a flowchart of the controlling processes of the drive motor 5 in a continuous mode, according to the first modification.

FIG. 21B is a flowchart of the controlling processes of the drive motor 5 in an intermittent mode, according to the first modification.

As illustrated in FIG. 21A, when an operator or user manipulates the mode switch 19 of the operation panel 16 to choose a continuous mode, the operation of a switch such as the on-off switch 20 and the foot switch 6 is set to an alternate mode. When the switch is touched or pressed down to turn on the switch and the medicine package sensor 40 is detecting a medicine package (YES in step S21 or step S22), in step S23, the drive motor 5 starts driving, and a medicine-package binding operation is performed.

When the medicine package sensor 40 does not detect a medicine package (NO in step S24) or when the switch is touched or pressed down by an operator again to turn off the switch (YES in step S25), in step S26, the drive motor 5 stops driving, and the medicine-package binding operation stops

As described above with reference to FIG. 21B, when an operator manipulates the mode switch 19 of the operation panel 16 to choose an intermittent mode, the operation of the switch is set to a momentary mode. When the switch is touched or pressed down by an operator to turn on the switch (YES in step S31) and when the medicine package sensor 40 is detecting a medicine package (YES in step S32), in step S33, the drive motor 5 starts driving, and a medicine-package binding operation is performed.

When the medicine package sensor 40 does not detect a medicine package (NO in step S34) or when the switch that has been touched or pressed down is released to turn off the switch (YES in step S35), in step S36, the drive motor 5 stops driving, and the medicine-package binding operation stops.

As described above, in the first modification, even if the switch is turned on, the drive motor 5 does not start driving when the medicine package sensor 40 does not detect a medicine package. Accordingly, the first gear 4a can be driven to rotate only when a plurality of medicine packages are crimp-bound, and the first gear 4a and the second gear 4b can be prevented from being worn.

### Second Modification

In the embodiments of the present disclosure as described above, with the foot switch 6, a binding operation for medicine packages can be performed with manipulations equivalent to those for the above-described on-off switch 20, and both the foot switch 6 and the on-off switch 20 are operable in any one of the continuous mode and the intermittent mode. Typically, a momentary operation is considered to be suitable for the foot switch 6, and when a medicine-package binding operation is performed as manipulated by the foot switch 6, the intermittent mode is selected.

As mentioned above, a momentary operation is considered to be suitable for the foot switch 6. For this reason, for example, when the continuous mode is selected as an operator forgot to switch the operation mode to the intermittent mode, the medicine-package binding operation does not stop even when a foot is released from the foot switch 6, and the operator may get confused and may make some errors in operation.

In order to avoid such errors, in this second modification of the above embodiments of the present disclosure, the foot switch 6 is operated only in the intermittent mode that adopts a momentary operation, and the on-off switch 20 is operated only in the continuous mode that adopts an alternating operation.

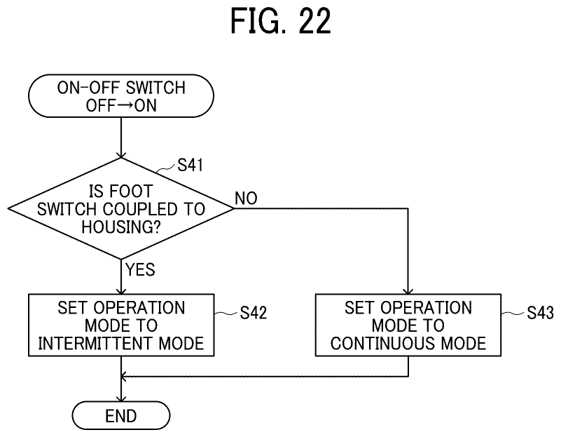

More specifically, in the second modification, the foot switch 6 is attachable to and detachable from the housing 2 of the medicine-package binding machine, and as illustrated in FIG. 22, when the foot switch 6 is not coupled to the housing 2 (NO in step S41), in step S43, the controller 50 sets the operation mode to a continuous mode that adopts an alternating operation. When the foot switch 6 is attached to the housing 2 and the foot switch 6 is coupled to the housing 2 (YES in step S41), in step S42, the controller 50 sets the operation mode to an intermittent mode that adopts a momentary operation. In this configuration, the on-off switch 20 is disabled, and no response is given even when the on-off switch 20 is touched or pressed down. In this second modification of the above embodiments of the present disclosure, the controller 50 serves as a selector. In this second modification of the above embodiments of the present disclosure, the mode switch 19 described above with reference to FIG. 11 is omitted on the operation panel 16, and only the pair of mode indicators 19a and 19b are made available.

Due to the adoption of such a configuration as described above, the intermittent mode is automatically selected when the foot switch 6 is coupled to the housing 2, and the labor or workload of an operator can be reduced compared with cases in which an operator manually selects the intermittent mode when the foot switch 6 is to be used. The foot switch 6 can be operated in the momentary mode that is considered to be suitable, and the chances of, for example, errors in operation can be reduced.

When the foot switch 6 is not coupled to the housing 2 and the binding operation is operated or manipulated by the on-off switch 20, the continuous mode that adopts an alternating operation is automatically selected. Due to such a configuration, the switch can be operated in a desired mode. More specifically, the on-off switch 20 is used when an alternate mode is desired for the operation, and the foot switch 6 is used when a momentary mode is desired for the operation. Accordingly, the labor of an operator before a switching operation can be reduced. More specifically, the labor of touching or pressing down the mode switch 19 to select a desired operation mode or the labor of checking which one of the LEDs of the pair of mode indicators 19a and 19b is turned on to check whether a desired operation mode is selected can be reduced.

Alternatively, under the condition that the foot switch 6 is coupled to the housing 2, the intermittent mode may automatically be selected when the foot switch 6 is operated, and the continuous mode may automatically be selected when the on-off switch 20 is operated. Due to such a configuration, when the alternate mode using the on-off switch 20 is desired for the operation, the labor of detaching the foot switch 6 can be reduced, and the degree of customer convenience can be increased.

Upon arranging the switch 21 with which the switch to be used can be selected as described above with reference to FIG. 19, the continuous mode may automatically be selected when the on-off switch 20 is selected by the switch 21, and the intermittent mode may automatically be selected when the foot switch 6 is selected by the switch 21. Due to such a configuration, when the alternate mode using the on-off switch 20 is desired for the operation, the labor of detaching the foot switch 6 can be reduced, and the degree of customer convenience can be increased. In this configuration, the mode switch 19 illustrated in FIG. 19 is omitted.

The above-described embodiments of the present disclosure are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

In the above-described embodiments, a medicine-package bundle is crimp-bound using the pair of gears 4a and 4b. However, no limitation is indicated thereby. For example, a pair of rotors with no teeth may be adopted, and the medicine-package bundle may be crimp-bound at a nip where one of the rotors is pressed against the other one of the rotors. For example, the media to be crimp-bound are not limited to medicine packages, and may be a sheet-like material such as sheets of paper.

The embodiments described above are given as an example, and advantageous effects are achieved for each of the following modes given below.

### First Aspect

A binding device such as the medicine-package binding machine 1 includes a switch such as the on-off switch 20 or the foot switch 6 to manipulate, based on a push of the switch by a user such as an operator, a crimping and binding operation in which a plurality of media to be bound such as a plurality of medicine packages are crimp-bound. The crimping and binding operation is performed when the switch is turned on, and the crimping and binding operation is stopped when the switch is turned off. The binding device includes a mode selector, which is implemented by, for example, the mode switch 19 or the controller 50 and includes a first operation mode such as the intermittent mode in which the switch is turned on while the switch is being pushed and the switch is turned off when the switch is released and a second operation mode such as the continuous mode in which the switch is kept being turned on or the switch is kept being turned off when the switch is pushed and then released and the switch is switched between a state in which the switch is turned on and a state in which the switch is turned off every time the switch is pushed, to choose one of the first operation mode and the second operation mode.

In a comparative example, a crimping and binding operation is manipulated in a so-called momentary mode as follows. The switch is turned on and the crimping and binding operation performed while the switch is being pushed, and the switch is turned off and the crimping and binding operation stops when the switch is no longer touched or pressed down and released. For this reason, for example, when a plurality of media to be bound that are long in the conveyance direction are continuously crimp-bound from the front end to the rear end in the conveyance direction, it is necessary for the switch to be kept touched or pressed down, and the workload of a user is not light.

By contrast, in the first aspect, the first operation mode that adopts a momentary operation and the second operation mode are arranged as above. In the second operation mode, the switch is kept being turned on or the switch is kept being turned off when the switch is pushed and then released and the switch is switched between a state in which the switch is turned on and a state in which the switch is turned off every time the switch is pushed, which may be referred to as an alternate mode. Accordingly, crimp binding can be performed in an appropriate operation mode depending on how crimp binding is to be performed.

For example, when a plurality of media to be bound that are long in the conveyance direction as above are continuously crimp-bound, the above second operation mode that adopts an alternating operation is selected. By so doing, the crimping and binding operation is performed without touching or pressing down the switch continuously, and the media to be bound can continuously be crimp-bound. Accordingly, compared with cases in which a crimping and binding operation is performed in a momentary mode, the workload of a user can be reduced, and crimp binding can easily be performed.

By contrast, for example, when crimp binding is to be performed as follows, a plurality of media to be bound can easily be crimp-bound with no mistake by selecting the above first operation mode that adopts a momentary operation. In such crimp binding, the crimping and binding operation is paused after a medium to be bound that is short in the conveyance direction is placed on media to be bound that are long in the conveyance direction and the medium to be bound and the media to be bound are crimp-bound. In such crimp binding, the crimping and binding operation is resumed after a medium to be bound that is short in the conveyance direction is placed again at a position upstream from a crimp-bound portion of the media to be bound that are long in the conveyance direction. Such crimp binding is intermittently performed. When crimp binding is to be performed intermittently as above, the first operation mode that adopts a momentary operation is selected. By stopping to touch or press down the switch, the crimping and binding operation can be paused at a desired timing, and the conveyance of media can be stopped at a desired position. Accordingly, the user can easily crimp and bind the media to be bound with no mistake, as compared with the case where the crimp binding is performed in the second operation mode of the alternate operation method.

### Second Aspect

In the first aspect, a pair of crimpers such as the pair of rotatable gears to rotate are further provided. The pair of crimpers crimp the plurality of media to be bound while conveying the plurality of media to be bound in the crimping and binding operation, and the switch such as the on-off switch 20 or the foot switch 6 manipulates rotation of the pair of crimpers.

Due to such a configuration, whether the crimping and binding operation is to be performed or stopped can be manipulated by the operation made on the switch.

### Third Aspect

In the second aspect, a medium sensor such as the medicine package sensor 40 to detect an entry of the plurality of media to be bound such as a plurality of medicine packages into the pair of crimpers such as the pair of gears 4a and 4b is further provided.

According to the present aspect, as described above in the first modification of the present disclosure, the pair of crimpers can be driven to rotate when it is detected that a medium sensor such as the medicine package sensor 40 has detected that a plurality of media to be bound such as a plurality of medicine packages have entered the pair of crimpers such as the pair of gears 4a and 4b. Accordingly, only when a plurality of media to be bound such as a plurality of medicine packages are made to enter the pair of crimpers such as the pair of gears 4a and 4b and those media to be bound are to be crimp-bound, the pair of crimpers can be driven to rotate, and the pair of crimpers can be prevented from being worn.

### Fourth Aspect

In the third aspect, the pair of crimpers such as the pair of gears 4a and 4b are driven to rotate when the medium sensor such as the medicine package sensor 40 detects the plurality of media to be bound and the switch is turned on.

According to the present aspect, as described above in the first modification of the present disclosure, only when a plurality of media to be bound such as a plurality of medicine packages are made to enter the pair of crimpers such as the pair of gears 4a and 4b and those media to be bound are to be crimp-bound, the pair of crimpers can be driven to rotate. Accordingly, the pair of crimpers can be prevented from being worn.

### Fifth Aspect

In any one of the second to fourth aspects, a rotation-speed switch such as the rotation-speed adjustment switches 18a and 18b to change a rotation speed of the pair of crimpers such as the pair of gears 4a and 4b is further provided.

Due to such a configuration, as described above in the embodiments of the present disclosure, the speed of binding operation can be adjusted to a convenient-to-use speed for user such as an operator.

### Sixth Aspect

In any one of the first to fifth aspects, each of the pair of crimpers is a gear.

Due to such a configuration, a plurality of media to be bound can be crimp-bound as desired.

### Seventh Aspect

In any one of the first to sixth aspects, two switches including a button switch such as the on-off switch 20 and a foot switch are further provided. The mode selector automatically selects the first operation mode such as the intermittent mode when the foot switch is to be used, and automatically selects the second operation mode when the button switch is to be used.

According to the present aspect, as described above in the second modification, the foot switch 6 can be operated in the momentary mode that is considered to be suitable, and a user can operate or manipulate the foot switch 6 without a sense of incongruity. Moreover, the switch can be operated in a desired mode, where a button switch such as the on-off switch 20 is used when an alternate mode is desired for the operation, and the foot switch 6 is used when a momentary mode is desired for the operation. Accordingly, the labor can be reduced compared with a configuration in which a desired operation mode is manually selected before a user such as an operator manipulates a switch.

### Eighth Aspect

In the seventh aspect, the foot switch is detachably attached to a housing of the binding device. The mode selector automatically selects the first operation mode when the foot switch is attached to the binding device, and automatically selects the second operation mode when the foot switch is detached from the binding device.

According to the present aspect, as described above in the second modification, the first operation mode such as the intermittent mode is automatically selected when the foot switch is to be used, and the second operation mode is automatically selected when the button switch is to be used.

### Ninth Aspect

In any one of the first to seventh aspects, two switches including a button switch such as the on-off switch 20 and a foot switch are further provided, and a switch selector for a user such as an operator to select the switch to be used between the button switch and the foot switch is further provided.

Due to such a configuration, as described above in the embodiments of the present disclosure, a user such as an operator can select a switch to be used as desired.

### Tenth Aspect

In any one of the first to ninth aspects, each one of the media to be bound is a medicine package.

Due to such a configuration, a plurality of medicine packages can easily be crimp-bound by a user.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disk (DVD), and/or the memory of an FPGA or ASIC.

What is claimed is:

1. A binding device comprising:
a switch to manipulate, based on a push of the switch, a crimping and binding operation in which a plurality of media to be bound are crimp-bound, the crimping and binding operation performed when the switch is turned on, the crimping and binding operation stopped when the switch is turned off; and
a mode selector to choose one of a first operation mode in which the switch is turned on while the switch is being pushed and the switch is turned off when the switch is released and a second operation mode in which the switch is kept being turned on or the switch is kept being turned off when the switch is pushed and then released and the switch is switched between a state in which the switch is turned on and a state in which the switch is turned off every time the switch is pushed.

2. The binding device according to claim 1, further comprising
a pair of crimpers to rotate,
wherein the pair of crimpers crimp the plurality of media to be bound while conveying the plurality of media to be bound in the crimping and binding operation, and
wherein the switch manipulates rotation of the pair of crimpers.

3. The binding device according to claim 2, further comprising
a medium sensor to detect an entry of the plurality of media to be bound into the pair of crimpers.

4. The binding device according to claim 3,
wherein the pair of crimpers are driven to rotate when the medium sensor detects the plurality of media to be bound and the switch is turned on.

5. The binding device according to claim 2, further comprising
a rotation-speed switch to change a rotation speed of the pair of crimpers.

6. The binding device according to claim 2,
wherein each of the pair of crimpers is a gear.

7. The binding device according to claim 1, further comprising
a button switch and a foot switch as the switch,
wherein the mode selector automatically selects the first operation mode when the foot switch is to be used, and automatically selects the second operation mode when the button switch is to be used.

8. The binding device according to claim 7,
wherein the foot switch is detachably attached to a housing of the binding device, and
wherein the mode selector automatically selects the first operation mode when the foot switch is attached to the binding device, and automatically selects the second operation mode when the foot switch is detached from the binding device.

9. The binding device according to claim 1, further comprising
a button switch and a foot switch as the switch; and
a switch selector to select the switch to be used between the button switch and the foot switch.

10. The binding device according to claim 1,
wherein each one of the media to be bound is a medicine package.
